(19) United States
(12) Patent Application Publication
(10) Pub. No.: US 2011/0050661 A1
(43) Pub. Date: Mar. 3, 2011

(54) LIQUID CRYSTAL DISPLAY DEVICE

(75) Inventors: Chan Min Chou, Taipei County (TW); Jhao Huei Liou, Taichung City (TW)

(73) Assignee: ALTEK CORPORATION, Hsinchu (TW)

(21) Appl. No.: 12/607,641

(22) Filed: Oct. 28, 2009

(30) Foreign Application Priority Data
Aug. 26, 2009 (TW) 098128729

(51) Int. Cl. G09G 3/36

(52) U.S. Cl. 345/207

(57) ABSTRACT

A liquid crystal display (LCD) device is capable of automatically adjusting a color display parameter according to external light. The LCD device includes an LCD panel, a backlight module, a photosensitive module, and a controller. The LCD panel has a display region and a light-incident region. The backlight module is disposed below the LCD panel and corresponding to the display region. The photosensitive module is disposed below the LCD panel and corresponding to the light-incident region, for receiving an optical signal passing through the LCD panel and converting the optical signal into an electrical signal. The controller is electrically connected to the LCD panel and the photosensitive module, for automatically adjusting a color display parameter of the LCD panel according to the electrical signal.

### CROSS-REFERENCE TO RELATED APPLICATIONS

This non-provisional application claims priority under 35 U.S.C. §119(a) on Patent Application No(s). 098128729 filed in Taiwan, R.O.C. on Aug. 26, 2009, the entire contents of which are hereby incorporated by reference.

### BACKGROUND OF THE INVENTION

1. Field of Invention

The present invention relates to a liquid crystal display (LCD) device, and more particularly to an LCD device capable of adjusting a display parameter according to external light.

2. Related Art

LCD screens have been widely applied to various types of electronic devices such as mobile phones, digital cameras, and notebooks. Most LCD screens may have their display parameters, such as brightness, contrast, and color saturation, adjusted by users, so as to enable the users to obtain a color information presentation suitable for their own visual perception.

Taking portable electronic devices such as the notebooks as an example, the user may carry a notebook to different environments and occasions for use, for example, outdoors with sufficient light, in a coffee shop with darker light, or in an office with medium light intensity. Under different light conditions, the display parameter adjusted by the LCD screen may not be suitable for all the light conditions, for example, the brightness of the LCD screen should be raised in a darker environment or lowered in an environment with medium light intensity. However, in the prior art, the brightness of external light may be detected with a photosensitive element such as an photoresistor, thereby automatically adjusting the brightness of the LCD screen according to the detected brightness of the external light.

However, the actual operating environment of the user is not only featured in brightness with different intensities, but also in other aspects such as the difference between indoor and outdoor ambient light source colors (red, green, and blue (RGB) values) and the light source color difference between indoor illuminators like fluorescent lamps and light bulbs. Therefore, the color display parameter (such as the RGB values, warm colors, and cold colors) adjusted by the LCD screen may not satisfy all the light source color differences. In other words, although the conventional LCD screen can automatically adjust the brightness of the LCD screen with a photosensitive element, the user still needs to manually control the color display parameter, i.e., the color display parameter of the LCD screen cannot be automatically adjusted according to the ambient light source color.

### SUMMARY OF THE INVENTION

Although the conventional LCD screen is capable of obtaining the brightness of external light with a photosensitive element and automatically adjusting the brightness of the LCD screen according to the brightness of the external light, the photosensitive element may not directly obtain light source color information about the external light. Therefore, the present invention is an LCD device capable of automatically adjusting a color display parameter according to light source color information.

The LCD device of the present invention comprises an LCD panel, a backlight module, a photosensitive module, and a controller. The LCD panel has a display region and a light-incident region. The backlight module is disposed below the LCD panel and corresponding to the display region. The photosensitive module is disposed below the LCD panel and corresponding to the light-incident region. The controller is electrically connected to the LCD panel and the photosensitive module. The backlight module provides a light source for the display of the LCD panel, and the photosensitive module receives an optical signal generated by the external light passing through the LCD panel. The external light is separated by a color filter in the LCD panel into an optical signal of RGB, and is received by the photosensitive module. The photosensitive module receives and converts the optical signal into an electrical signal, and transmits the electrical signal to the controller. Thereby, the controller is enabled to automatically adjust a color display parameter of the LCD panel according to the electrical signal.

In the LCD device of the present invention, a display region and a light-incident region are formed on the LCD panel, and a backlight module and a photosensitive module are respectively disposed in the two regions, so that the LCD panel may sense the color of the external light with the photosensitive module and adjust the color display parameter of the LCD panel according to the change of the color of the external light, in addition to maintaining the original LCD function with the light source projection of the backlight module. In this manner, the contrast effect between the display color of the LCD panel and the color of the external light as well as the display quality of the frame color can be improved.

### BRIEF DESCRIPTION OF THE DRAWINGS

The present invention will become more fully understood from the detailed description given herein below for illustration only, and thus are not limitative of the present invention, and wherein:

FIG. 1 is a schematic cross-sectional top view of an LCD device according to an embodiment of the present invention;

FIG. 2 is a schematic front view of the LCD device according to the embodiment of the present invention;

FIG. 3 is a schematic view illustrating an operation of the LCD device according to the embodiment of the present invention;

FIG. 4 is a schematic cross-sectional top view of the LCD device with two light-incident regions and two photosensitive modules according to the embodiment of the present invention; and

FIG. 5 is a schematic front view of the LCD device with two light-incident regions and two photosensitive modules according to the embodiment of the present invention.

### DETAILED DESCRIPTION OF THE INVENTION

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention. The following embodiments are intended to describe the present invention in further detail, but not intended to limit the scope of the present invention in any way.

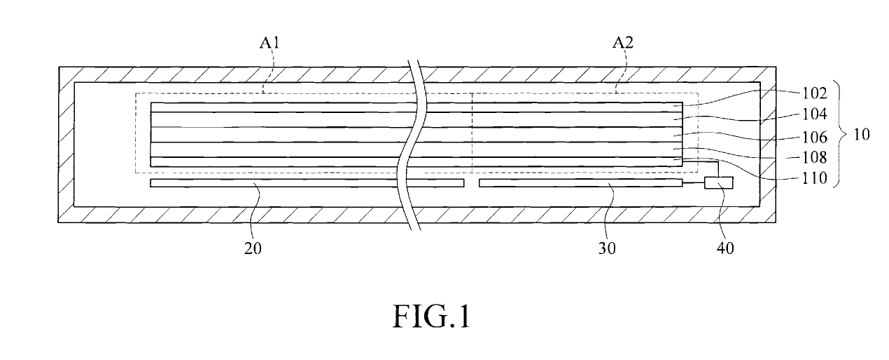

Referring to FIG. 1, the LCD device of the present invention comprises an LCD panel 10, a backlight module 20, a photosensitive module 30, and a controller 40. The controller 40 is a microcontroller unit (MCU), and electrically connected to the LCD panel 10 and the photosensitive module 30. The LCD panel 10 substantially comprises a first polarization plate 102 and a second polarization plate 110, and a color filter 104, a liquid crystal layer 106, and a thin-film transistor (TFT) module 108 are disposed between the first and second polarization plates 102 and 110. The liquid crystal layer 106 comprises a plurality of liquid crystal molecules, and the TFT module 108 comprises electronic elements (not shown) such as a drive integrated circuit (IC) and a printed circuit board (PCB).

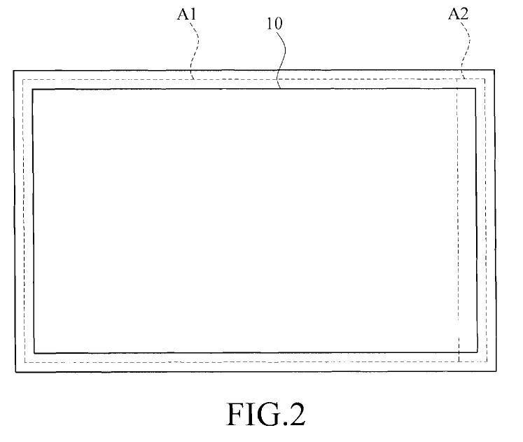

Referring to FIGS. 1 and 2, a display region A1 and a light-incident region A2 are respectively defined on the LCD panel 10. The backlight module 20 and the photosensitive module 30 are disposed below the LCD panel 10 (i.e., at a side adjacent to the second polarization plate 110). The backlight module 20 is disposed corresponding to the display region A1 of the LCD panel 10, and the photosensitive module 30 is disposed corresponding to the light-incident region A2 of the LCD panel 10. The photosensitive module 30 is formed by light sensor elements which are capable of receiving an optical signal and converting the optical signal into an electrical signal, such as a charge coupled device (CCD), a complementary metal-oxide-semiconductor (CMOS), or a light sensor array composed of a plurality of photoelectric sensors.

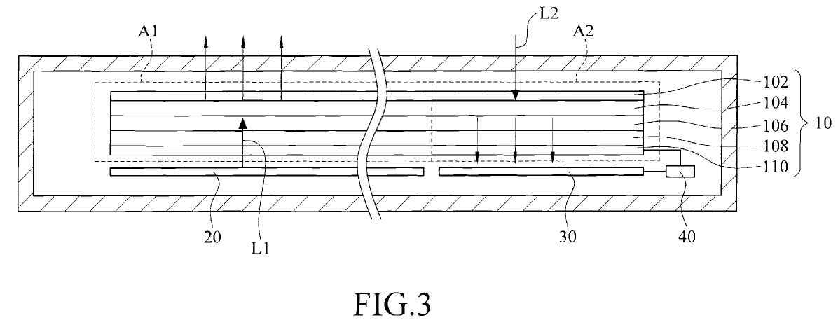

Referring to FIG. 3, when the LCD device of the present invention is in use, the backlight module 20 provides a uniform light source L1 with sufficient brightness and projects the light source onto the LCD panel 10. Non-polarized light is converted into polarized light by the second polarization plate 110. Meanwhile, a voltage of the drive IC in the TFT module 108 is changed, so as to enable the liquid crystal molecules in the liquid crystal layer 106 to generate a motion and alter their original arrangement accordingly by controlling the electric field of the drive IC. For example, the liquid crystal molecules stand upright or twist in the liquid crystal layer 106, so as to control the transmittance of the light source L1 provided by the backlight module 20. Therefore, when the light emitted by the light source L1 passes through the liquid crystal layer 106, the advancing direction of a part of the light is rotated to smoothly pass through the color filter 104 and the first polarization plate 102, and the other part of the light that is not rotated is blocked, thereby controlling the presentation of color frames on the LCD panel 10. This is a common frame display mode of the LCD panel 10, and is not a technical feature that the present invention is intended to emphasize, so the detailed structures and operating principle thereof will not be described again herein.

Referring to FIGS. 1 to 3, when the LCD device provides the light source L1 on the LCD panel 10 by using the backlight module 20 and performs a frame display operation in the display region A1 of the LCD panel 10, external light L2 present in the operating environment of the LCD device enters the LCD panel 10 through the light-incident region A2 of the LCD panel 10 at the same time. Similarly, when the external light L2 enters the LCD panel 10, non-polarized light is converted into polarized light by the first polarization plate 102, then separated by the color filter 104 and implemented by color processing of RGB, and finally passes through the TFT module 108 and the second polarization plate 110 to generate an optical signal of RGB of the external light L2. The optical signal is received by the photosensitive module 30.

After receiving the optical signal, the photosensitive module 30 converts the optical signal into an electrical signal based on intensities of the RGB of the external light L2 in the optical signal, and transmits the electrical signal to the controller 40. The controller 40 adjusts a color display parameter of the LCD panel 10 according to the electrical signal, so that the display frame color presented by the LCD panel 10 can be automatically adjusted to the optimal with the light source color of the external environment of the LCD device. For example, when the user operates the LCD device in an environment with a yellowish light color, the external light in a yellowish color passes through the LCD panel 10 from the light-incident region A2 of the LCD panel 10, and is received and converted by the photosensitive module 30 into an electrical signal. The photosensitive module 30 then transmits the electrical signal to the controller 40. The controller 40 adjusts the color display parameter of the LCD panel 10 based on the information about the yellowish color conveyed by the electrical signal, so that a contrast effect between the frame color displayed by the LCD panel 10 and the color of the external light is generated.

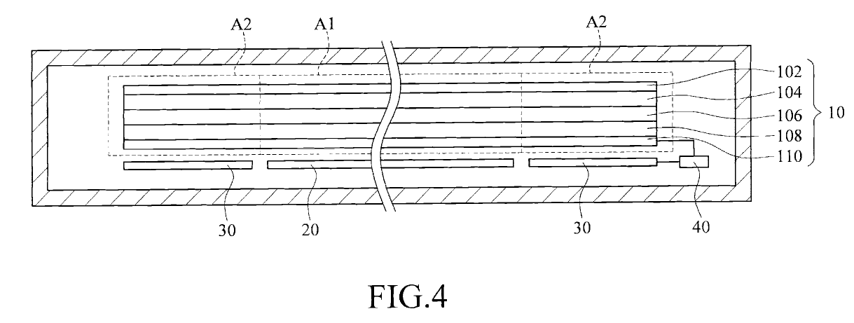

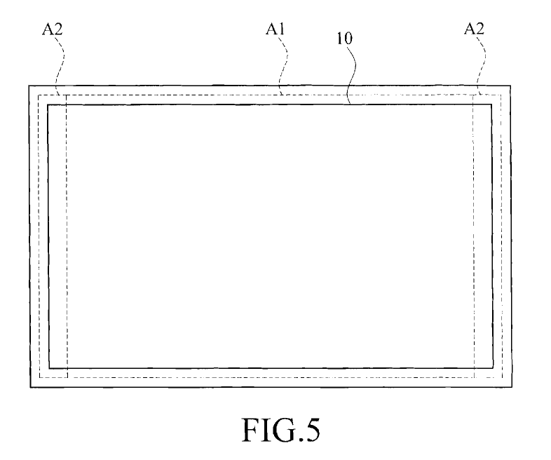

Further, in order to increase the light color sensing speed of the photosensitive module 30 to the operating environment of the LCD device and more accurately grasp the change and uniformity of the color of the external light, a plurality of photosensitive modules 30 is disposed in the LCD device and a plurality of light-incident regions A2 is disposed on the LCD panel 10. For example, the above purpose can be realized by disposing two photosensitive modules 30 in the LCD device and disposing two light-incident regions A2 on the LCD panel 10 (as shown in FIGS. 4 and 5). The number of the photosensitive module 30 and the light-incident region A2 is for illustration only, instead of limiting the present invention.

In the LCD device of the present invention, a light-incident region is formed on the LCD panel and a photosensitive module is disposed corresponding to the light-incident region by properly reducing the size of the backlight module in the display region (light transmission range) on the LCD panel. In this manner, the LCD device may sense the color of the external light with the photosensitive module and adjust the color display parameter of the LCD panel according to the detected photoelectric signal, in addition to maintaining the original color frame display function. Thereby, the contrast effect between the display color of the LCD panel and the color of the external light as well as the display quality of the frame color can be improved.

What is claimed is:

1. A liquid crystal display (LCD) device, comprising:
an LCD panel, having a display region and a light-incident region;
a backlight module, disposed below the LCD panel and corresponding to the display region;
a photosensitive module, disposed below the LCD panel and corresponding to the light-incident region, for receiving an optical signal passing through the LCD panel and generating an electrical signal; and
a controller, electrically connected to the LCD panel and the photosensitive module, for receiving the electrical signal and adjusting a color display parameter of the LCD panel according to the electrical signal.

2. The LCD device according to claim 1, wherein the photosensitive module is a charge coupled device (CCD).

3. The LCD device according to claim 1, wherein the photosensitive module is a complementary metal-oxide-semiconductor field effect transistor (CMOSFET).

4. The LCD device according to claim 1, wherein the photosensitive module is a light sensor array.
